(19) United States
(12) Patent Application Publication
(10) Pub. No.: US 2025/0246129 A1
(43) Pub. Date: Jul. 31, 2025

(54) Driving structure for display panel

(71) Applicant: Sitronix Technology Corporation, Hsinchu County (TW)

(72) Inventor: Chung-Hsin Su, Hsinchu County (TW)

(21) Appl. No.: 19/036,100

(22) Filed: Jan. 24, 2025

Related U.S. Application Data
(60) Provisional application No. 63/624,807, filed on Jan. 25, 2024.

(51) Int. Cl. G09G 3/32

(52) U.S. Cl. CPC G09G 3/32; G09G 2330/021; G09G 2370/08

(57) ABSTRACT

The present application discloses a driving structure for a display panel, which comprises a controller and at least one driver. The controller is disposed on the display panel, the controller generates a data signal and a data clock signal. The at least one driver is disposed on the display panel, the at least one driver receives the data signal and the data clock signal. The controller sets a signal level of the data clock signal according to whether the at least one driver needs to update data thereof.

### FIELD OF THE INVENTION

The present application relates to a driving structure, particularly to a driving structure for a display panel.

### BACKGROUND OF THE INVENTION

In display panels with a plurality of drivers, the controller transmits a plurality of clock signals to the drivers, which operate according to the timing of the clock signals to drive the light-emitting components.

The controller transmits a data signal in each period of a data clock signal. When a driver receives an enable signal, the driver will receive the data signal according to the timing of the data clock signal. After a first driver finishes receiving the data signal, the first driver will transmit another enable signal for notifying a second driver starting to receive the data signal. In this way, the drivers in the same row will complete the operation of receiving data in sequential. If the data signal needs to be transmitted again, the controller will first transmit a low-level enable signal, so that all of the drivers in the same row will transmit the low-level enable signal. Afterward, the controller transmits a high-level enable signal to the first driver, and then, receiving of the data signal will start from the first driver.

Since the display panel with a plurality of drivers usually is equipped with a large number of drivers in the display panel, when one of the drivers needs to update the data signal, the update operation must be restarted from the first driver according to the above operation of receiving the data signal, thereby, a lot of time are consumed and the efficiency of updating the data signal will be reduced.

Based on the above, the present application provides a driving structure for a display panel that may solve the above-mentioned time-consuming technical problem, increase the efficiency of updating data signals of the display panel, and reduce the time required for updating data of the driver.

### SUMMARY

An objective of the present application is to provide a driving structure for a display panel, wherein a controller sets signal levels of a data signal and a data clock signal according to whether at least one driver needs to update data thereof.

An objective of the present application is to provide a driving structure for a display panel, wherein a driver transmits an enable signal and transfers it to another driver, that needs to update data thereof, according to a level variation of the data signal.

An objective of the present application is to provide a driving structure for a display panel, where the driver transmits an enable signal according to the level variation of the data signal and transmits it to the driver that needs to update the data thereof, the operation time of data update may be greatly reduced and the technical effect of saving power is achieved.

The present application provides a driving structure for a display panel, comprising a controller, and at least one driver. The controller and at least one driver are disposed on the display panel. The controller generates a data signal and a data clock signal, which are received by at least one driver. The controller sets a signal level of the data clock signal according to whether at least one driver needs to update the data thereof. By using this driving structure for a display panel, the data clock signal level may be set according to whether the driver needs to update the data thereof, and the enable signal is sent to the driver that needs to update the data thereof according to the timing of the data signal. Thereby, the operation time of data update in the display panel will be greatly reduced, the efficiency of data update may be improved, and the technical effect of saving power is further achieved.

### BRIEF DESCRIPTION OF THE DRAWINGS

FIG. 1: which is a schematic diagram of the driving structure for a display panel according to the present application;

FIG. 2: which is a partial schematic diagram of the driving structure according to an embodiment of the present application;

FIG. 3: which is a timing schematic diagram of clock signals according to an embodiment of the present application;

FIG. 4: which is a timing schematic diagram of the clock signals according to another embodiment of the present application; and

FIG. 5: which is a timing schematic diagram of the clock signals according to another embodiment of the present application.

### DETAILED DESCRIPTION

To provide the esteemed reviewers with a further understanding and appreciation of the features and effects achieved by the present application, detailed explanations are provided herein along with examples.

Certain terms used in the specification and claims refer to specific components; however, those skilled in the art should understand that manufacturers may use different terms to refer to the same component. Furthermore, the specification and claims do not distinguish components based on the difference in terms, but rather on the technical differences of the components. The term “comprising” mentioned throughout the specification and claims is an open-ended term and should be interpreted as “including but not limited to.” Moreover, the term “coupling” here includes any direct and indirect means of connection. Therefore, if the text describes a first device coupled to a second device, it implies that the first device can be directly connected to the second device, or indirectly connected through other devices or means of connection.

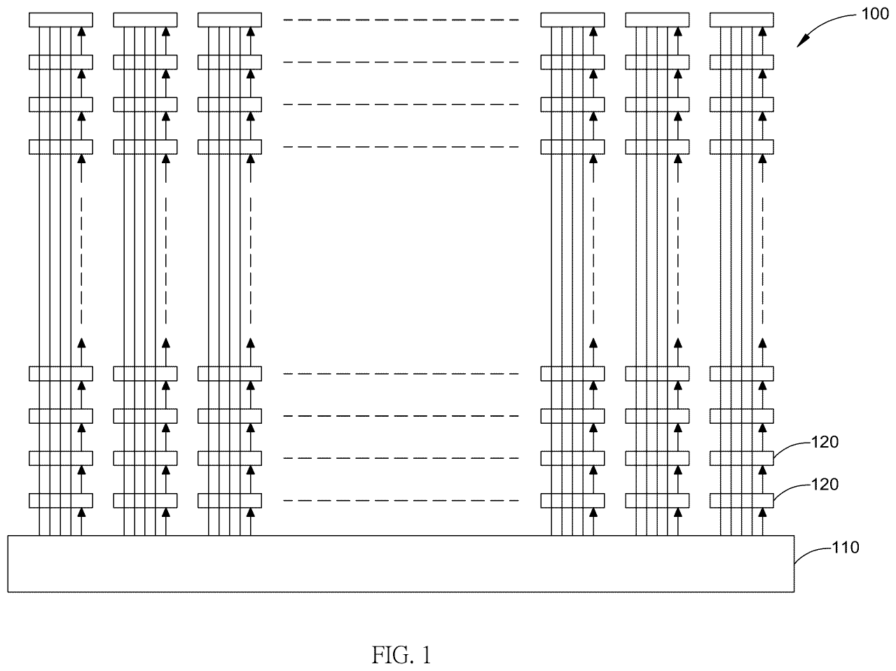

Please refer to FIG. 1, which is a schematic diagram of the driving structure for a display panel according to the present application. The driving structure according to the present application is configured to drive a display panel 100 to display images. The display panel 100 includes a controller 110 and at least one driver 120, with a plurality of drivers 120 exemplified in this embodiment. The controller 110 is disposed on the display panel 100 and is coupled to the at least one driver 120. The at least one driver 120 is disposed on the display panel 100, with the plurality of drivers 120 in the same row being coupled to each other in series.

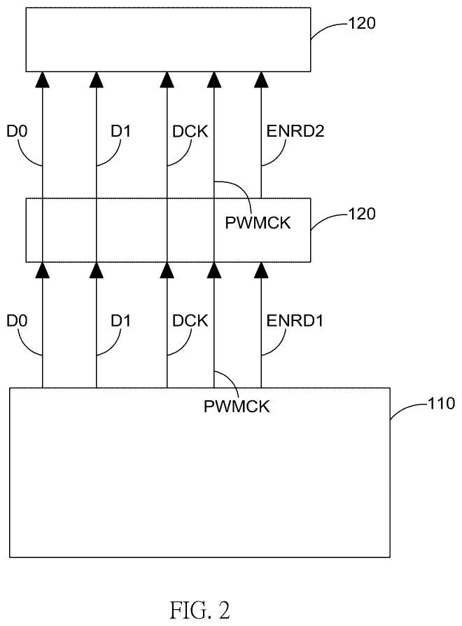

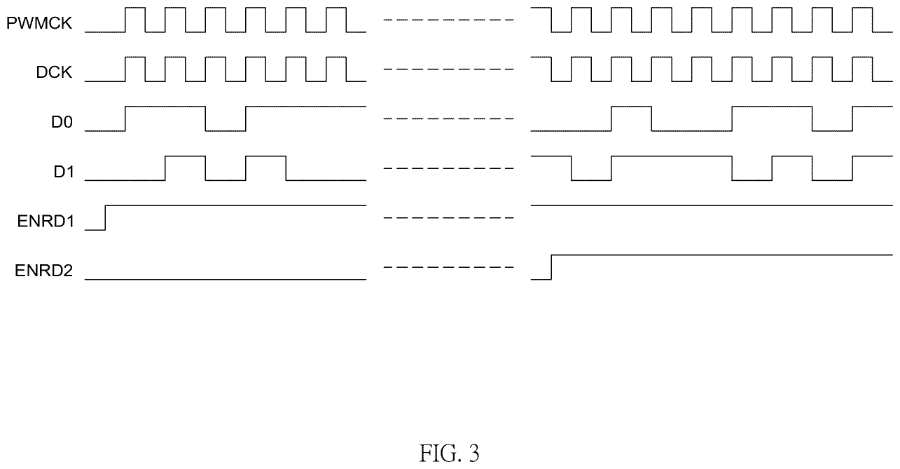

Please refer to FIG. 2 and FIG. 3, which are a partial schematic diagram of the driving structure and a timing schematic diagram of clock signals according to an embodiment of the present application. The controller 110 generates data signals D0 and D1, a data clock signal DCK, a display clock signal PWMCK, and an enable signal ENRD1. The controller 110 transmits the data signals D0 and D1, the data clock signal DCK and the display clock signal PWMCK to the at least one driver 120, in this embodiment, the enable signal ENRD1 is sent to the at least one driver 120 near by the controller 110.

In this embodiment, the data signals D0 and D1 are display data, which may be serial data and includes a plurality of pixel data, used for displaying images on display panel 100. The data line transmitting the data signals D0 and D1 is exemplified here as two lines, but the amount of the data lines may vary depending on the size of the panel or application circumstances. The data clock signal DCK is a timing signal, and the driver 120 receives the data signals D0 and D1 according to the timing of the data clock signal DCK. The display clock signal PWMCK is a timing signal, and the driver 120 drives the light-emitting components to turn on or off according to the timing of the display clock signal PWMCK. The enable signals ENRD1, ENRD2 are timing signals, and the driver 120 starts to receive the data signals D0 and D1, the data clock signal DCK, the display clock signal PWMCK according to the corresponding enable signal, for example, when the driver 120 receives a high level of the enable signal ENRD1, it indicates that the driver 120 is chose and starts to receive the data signals D0 and D1, the data clock signal DCK, the display clock signal PWMCK. Until current stage of the driver 120 complete receiving the data signals D0 and D1, the driver 120 transmits another enable signal to next stage of the driver 120, for driving the next stage of the driver 120 start to execute the receiving operation, for example, after a first driver 120 receives the data signals D0 and D1, and the first driver 120 transmits the enable signal ENRD2 to a second driver 120. Afterward, the second driver 120 starts to receive the data signals D0 and D1, the data clock signal DCK, the display clock signal PWMCK. Wherein the current stage of the driver 120 is coupled to the next stage of the driver 120 in series, as shown in FIG. 1 and FIG. 2.

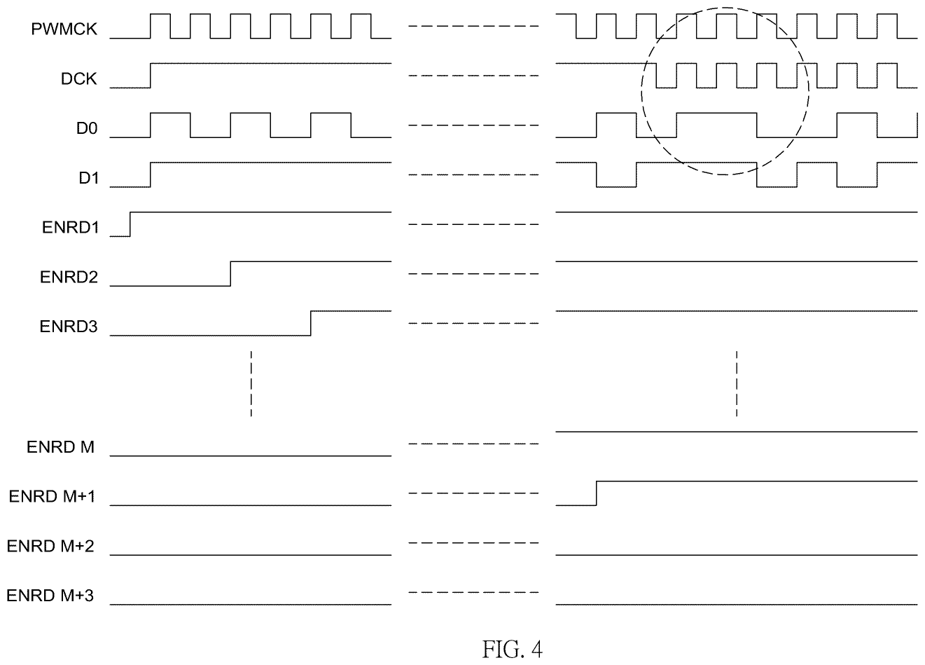

Please refer to FIG. 4, which is a timing schematic diagram of the clock signals according to another embodiment of the present application. Also, please refer to FIG. 2 and FIG. 4, in this embodiment, for the convenience of description, with a M+1th driver 120 needing update the data thereof exemplified in this embodiment. The controller 110 set a signal level of the data clock signal DCK according to whether the at least one driver 120 needs to update the data thereof, for example, assuming the data clock signal DCK and the data signal D1 having fixed levels, the data signal D0 as a timing signal, the driver 120 transmits the enable signal according to the timing of the data signal D0 while the driver 120 receives the data clock signal DCK and the data signal D1 with the fixed levels.

In this embodiment, when the first driver 120 receives the enable signal ENRD1 generated by the controller 110, the first driver 120 starts to receive the data clock signal DCK and the data signals D0 and D1. When the first driver 120 receives the data clock signal DCK and the data signal D1 fixed at a high level, the first driver 120 transmits the enable signal ERND2 to the next driver 120, that is, the second driver 120, according to the timing of the data signal D0, and so on. For example, the first driver 120 transmits the enable signal ERND2 to the next driver 120 according to the level variation of the data signal D0, and the level variation is, for example, from a low level to a high level or from a high level to a low level. When the Mth driver transmits the M+1th enable signal ENRDM+1 to the M+1th driver 120, that is, when the enable signal is transmitted to the driver 120 that needs to update the data thereof, the controller 110 sets the data clock signal DCK as the timing signal, and the data signals D0 and D1 are set to a data transmission state. The data signals D0 and D1 are pixel data. As shown in the dotted circle of FIG. 4, after the M+1th driver 120 receives the M+1th enable signal ENRDM+1 with the high-level, the M+1th driver 120 starts to receive the data clock signal DCK and the data signals D0 and D1, and the M+1th driver 120 updates the data thereof, for completing the data update operation of the M+1th driver.

In an embodiment, the controller 110 sets the data clock signal DCK and the data signal D0 to fixed levels, and sets the data signal D1 to a timing signal. The driver 120 receives the fixed-level data clock signal DCK and the data signal D0, and sends an enable signal according to the timing of the data signal D1.

In an embodiment, the driver 120 transmits the enable signal according to the number of level changes of the data signal. For example, the first driver 120 transmits the enable signal ERND2 to the second driver 120 according to the number of level changes the data signal D0 or of the data signal D1. The number of level change is, for example, 3 times from a low level to a high level or 3 times from a high level to a low level. The number of level changes may be any number, and the present application is not limited thereto.

In an embodiment, the driver 120 transmits the enable signal according to a level variation of a data signal. For example, the first driver 120 transmits the enable signal ERND2 to the second driver 120 according to the level variation of the data signal D0 or the data signal D1. In this embodiment, the controller 110 sets the data clock signal DCK to a fixed level, and sets the data signal D0 or the data signal D1 as a timing signal. The signal timing of FIG. 4 exemplified as follow, the data clock signal DCK is set to a fixed level, and the data signal D0 is set as a timing signal. After the driver 120 receives the data clock signal DCK with the fixed level, the driver 120 transmits the enable signal according to the timing variation of the data signal D0. The operation method of this embodiment may be used to simplify the signal timing control and use less signals for updating the data of the driver.

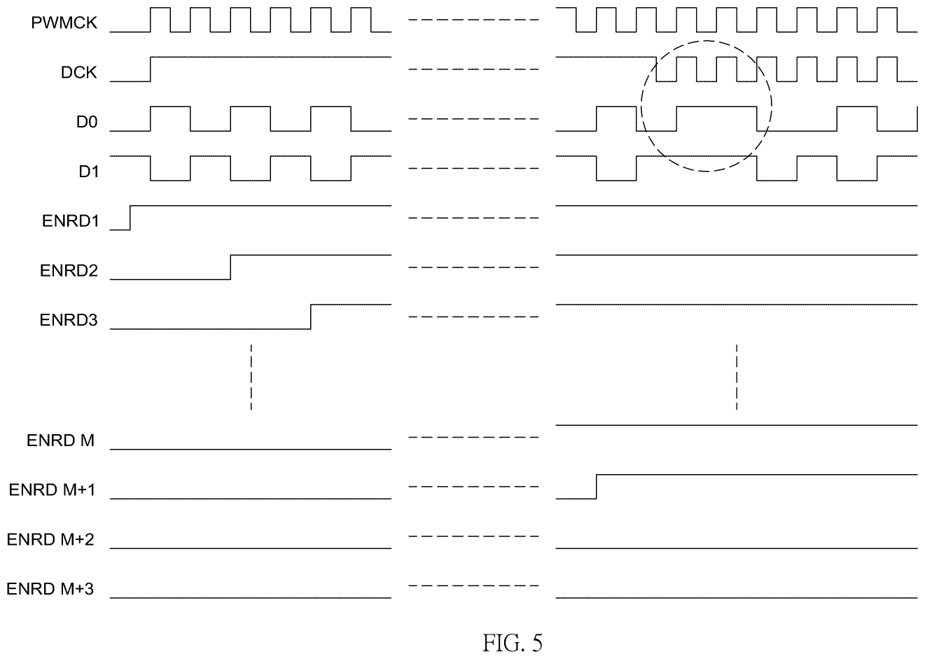

Please refer to FIG. 5, which is a timing schematic diagram of the clock signal according to another embodiment of the present application. Please refer to FIG. 2 and FIG. 5 at the same time. In this embodiment, for the convenience of description, exemplifying the M+1th driver 120 needs to update the data thereof. The controller 110 sets the signal level of the data clock signal DCK according to whether the at least one driver 120 needs to update the data thereof, for example, setting the data clock signal DCK to a fixed level, and setting the data signal D0 and the data signal D1 as timing signals, for example, setting the timing signal levels of the data signal D0 and the data signal D1 to be inverted. The driver 120 receives the data clock signal DCK with a fixed level, and transmits the enable signal according to the timing of the data signals D0 and D1. In this embodiment, the timing signal levels of the data signal D0 and the data signal D1 may be set to other levels according to actual conditions, such as setting timing signal levels to be in phase with each other, but the present application is not limited thereto.

In this embodiment, when the first driver 120 receives the enable signal ENRD1 generated by the controller 110, the first driver 120 starts to receive the data clock signal DCK and the data signals D0 and D1. When the first driver 120 receives the data clock signal DCK fixed at a high level, the first driver 120 transmits the enable signal ERND2 to the next driver 120, that is, the second driver 120, according to the timing of the data signals D0 and D1, and so on. For example, the first driver 120 transmits the enable signal ERND2 to the next driver 120 according to the level variation of the data signals D0 and D1. When the Mth driver 120 transmits the M+1th enable signal ENRDM+1 to the M+1th driver 120, that is, when the enable signal is transmitted to the driver 120 that needs to update the data thereof, the controller 110 sets the data clock signal DCK as the timing signal, and sets the data signals D0 and D1 to the data transmission state. The data signals D0 and D1 are pixel data, as shown in the dotted circle of FIG. 4. After the M+1th driver 120 receives the high-level M+1th enable signal ENRDM+1, the M+1th driver 120 starts to receive the data clock signal DCK and the data signals D0 and D1, and the M+1th driver 12 updates the data thereof, for completing the data update operation of the M+1th driver 120.

The display panel 100 according to the present application may be a micro light-emitting diode (Micro LED) panel, a mini light-emitting diode (mini LED) panel, or other light-emitting component display panel.

By using the driving structure for a display panel according to the present application, wherein while a driver needs to update the data thereof, the levels of the data clock signal and the data signal may be set so that other drivers, that do not need to update the data thereof, may transmit the enable signals according to the timing of the data signal until the driver, that needs to update the data thereof, performs the data update operation. Thereby, the overall data update efficiency of the display panel may be greatly increased, the time required for updating the data of the driver may be reduced, and the power consumed by the display panel may be further reduced, accordingly, the technical effect of saving power may be achieved.

Therefore, the present application indeed possesses novelty, progressiveness, and industrial applicability, undoubtedly meeting the requirements for a patent application under the national patent law. Accordingly, a patent application has been legally filed, earnestly praying for the patent application grant to be issued soon.

However, the above description is merely an embodiment of the present application and is not intended to limit the scope of the present application. Therefore, all equivalent modifications and variations according to the structure, and the features described in the scope of the patent application should be included within the scope of this patent application.

What is claimed is:

1. A driving structure for a display panel, comprising:
a controller, disposed on the display panel, generating a data signal and a data clock signal; and
at least one driver, disposed on the display panel, receiving the data signal and the data clock signal, wherein the controller sets a signal level of the data clock signal according to whether the at least one driver needs to update data thereof.

2. The driving structure of claim 1, wherein the at least one driver receives the data signal according to a timing of the data clock signal.

3. The driving structure of claim 1, wherein the controller sets a signal level of the data signal and the signal level of the data clock signal according to whether the at least one driver needs to update the data thereof.

4. The driving structure of claim 1, wherein the at least one driver comprises a first driver and a second driver, the controller transmits a first enable signal to the first driver, the first driver transmits a second enable signal to the second driver according to the data signal and the data clock signal.

5. The driving structure of claim 4, wherein the first driver starts to receive the data signal and the data clock signal according to the first enable signal, and the second driver starts to receive the data signal and the data clock signal according to the second enable signal.

6. The driving structure of claim 1, wherein the data signal comprises a first data signal and a second data signal, the data clock signal and the second data signal are set to fixed levels, the at least one driver transmits an enable signal according to a level variation of the first data signal.

7. The driving structure of claim 6, wherein the first data signal and the second data signal are changed to a data transmission state when the at least one driver executes updating of the data and receives the enable signal.

8. The driving structure of claim 1, wherein the data signal comprises a first data signal and a second data signal, the data clock signal and the first data signal are set to fixed levels, the at least one driver transmits an enable signal according to a level variation of the second data signal.

9. The driving structure of claim 8, wherein the first data signal and the second data signal are changed to a data transmission state when the at least one driver executes updating of the data and receives the enable signal.

10. The driving structure of claim 1, wherein the data signal comprises a first data signal and a second data signal, the data clock signal is set to a fixed level, signal levels of the first and second data signals are in phase or inverted, at least one driver transmits an enable signal according to level variations of the first and second data signals.

11. The driving structure of claim 10, wherein the first data signal and the second data signal are changed to a data transmission state when the at least one driver executes updating of the data and receives the enable signal.
